(19) United States
(12) Patent Application Publication
(10) Pub. No.: US 2016/0196305 A1
(43) Pub. Date: Jul. 7, 2016

(54) ANALYZING USER BEHAVIORS

(71) Applicant: EMC Corporation, Hopkinton, MA (US)

(72) Inventors: Jingjing Liu, Shanghai (CN); Chao Chen, Shanghai (CN); Tony Jiang Ma, Shanghai (CN); Paco Junjie Xu, Shanghai (CN); Jeremy Xiaofeng Wei, Shanghai (CN)

(21) Appl. No.: 14/971,036

(22) Filed: Dec. 16, 2015

(30) Foreign Application Priority Data
Jan. 4, 2015 (CN) CN201510003757.0

(51) Int. Cl. G06F 17/30

(52) U.S. Cl. CPC G06F 17/30489; G06F 17/30495

(57) ABSTRACT

Embodiments of the present invention relate to a method and system for analyzing user behaviors. The method comprises: generating action sequences according to action identifications in user behavior records; determining a common subsequence based on the action sequences, the common subsequence being a subsequence that is common to at least two action sequences among the action sequences; and constructing a sequence pattern based on the common subsequence.

### RELATED APPLICATIONS

This application claims priority from Chinese Patent Application Number CN201510003757.0 filed on Jan. 4, 2015 entitled “METHOD AND APPARATUS FOR ANALYZING USER BEHAVIOR” the content and teachings of which is herein incorporated by reference in its entirety.

### FIELD OF THE INVENTION

Embodiments of the present invention generally relate to data processing, and more particularly, to a method and apparatus for analyzing user behaviors.

### BACKGROUND OF THE INVENTION

In the data processing area, research on user behaviors has caught more and more attention. User behaviors may include various actions and/or operations that are executed when users access applications, browse pages, and so on. For example, regarding architecture like Software-as-a-Service (SaaS) that provides applications on a web/mobile basis, by analyzing user behaviors, users' preferences can be determined more conveniently and accurately and further users can be served more efficiently.

Web/mobile based applications might include various services. When a user interface designer designs an interface for web/mobile based applications, he/she usually takes into consideration services' functionality instead of individual user demands. For individual users, they might have to spend huge time or efforts looking for desired applications or services, which significantly degrades user experience.

Therefore, in the traditional solutions there are still problems and defects for improvement with respect to user experience.

### SUMMARY OF THE INVENTION

In view of the foregoing and other potential problems, there is a need in the art for a solution for analyzing user behaviors to improve user experience. According to embodiments of the present invention, based on analysis of user behaviors, more pertinent services or applications can be provided for users, and thereby user experience can be improved effectively.

According to one aspect of the present invention, there is provided a method for analyzing user behaviors, the method comprising: generating action sequences according to action identifications in user behavior records; determining a common subsequence based on the action sequences, the common subsequence being a subsequence that is common to at least two action sequences among the action sequences; and constructing a sequence pattern based on the common subsequence.

According to another aspect of the present invention, there is provided an apparatus for analyzing user behaviors, the apparatus comprising: a generating unit configured to generate action sequences according to action identifications in user behavior records; a determining unit configured to determine a common subsequence based on the action sequences, the common subsequence being a subsequence that is common to at least two action sequences among the action sequences; and a constructing unit configured to construct a sequence pattern based on the common subsequence.

As to be understood from detailed description below, according to embodiments of the present invention, a sequence pattern about actions performed by a user may be constructed according to user behavior records, so that more pertinent services or applications may be provided for the user. In particular, compared with the conventional solutions, embodiments of the present invention can facilitate users to customize personalized homepages, promote the implementation of test cases and further optimize user interface design. Further, embodiments of the present invention can automatically analyze time-consuming actions and pre-process them, thereby increasing the system response speed and effectively improving user experience. Still further, embodiments of the present invention can alert unsafe user actions and thereby increase the system stability and reliability.

### BRIEF DESCRIPTION OF THE DRAWINGS

Through the detailed description of some embodiments of the present disclosure in the accompanying drawings, the features, advantages and other aspects of the present invention will become more apparent, wherein several embodiments of the present invention are shown for the illustration purpose only, rather than for limiting. In the accompanying drawings:

FIG. 1 shows a block diagram of a system for analyzing user behaviors according to one exemplary embodiment of the present invention;

FIG. 2 shows a flowchart of a method for analyzing user behaviors according to one exemplary embodiment of the present invention;

FIG. 3 shows a flowchart of a method for analyzing user behaviors according to another exemplary embodiment of the present invention;

FIG. 4 shows a block diagram of an apparatus for analyzing user behaviors according to one exemplary embodiment of the present invention; and

FIG. 5 shows a block diagram of a computer system which is applicable to implement the embodiments of the present invention.

Throughout the figures, the same or corresponding numerals refer to the same or corresponding parts.

### DETAILED DESCRIPTION OF EMBODIMENTS

Hereinafter, principles and spirit of the present invention will be described with reference to several exemplary embodiments shown in the drawings various. It should be understood that provision of these embodiments is only to enable those skilled in the art to better understand and further implement the present invention but not to limit the scope of the present invention in any manner.

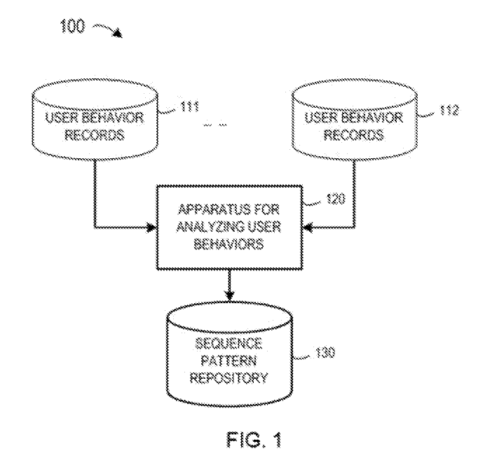

With reference to FIG. 1 first, this figure shows a block diagram of a system 100 for analyzing user behaviors according to one exemplary embodiment of the present invention.

As shown in FIG. 1, in the system 100, there are user behavior records 111 and 112, an apparatus 120 for analyzing user behaviors according to embodiments of the present invention, and a sequence pattern repository 120. By means of the apparatus 120 for analyzing user behaviors, one or more sequence patterns may be constructed from user behavior records 111 and 112, and thus a sequence pattern repository 130 may be generated.

User behavior records 111 and 112 are records of user behaviors. According to embodiments of the present invention, user behavior records 111 and 112 may include logs at a server side, logs at a client side, and any other files for recording user behaviors, and so on. In one embodiment, user behavior records may include one or more user session identifications (IDs) and one or more actions associated with each user session ID. An action ID may be a unique identification of each user interface component. For example, the action ID may be an identification that is defined for a user interface component when designing the SaaS Web/mobile user interface. An action ID and its associated user session ID may constitute an identifier. An example of the identifier format is shown below:

TABLE 1

| | |
|---|---|
| User Session ID | Action ID |

Thereby, the user behavior records may comprise one or more identifiers, each of which can be used to trace and represent user behaviors. The identifiers can be passed to the server side within HTTP requests when the user performs actions at the client side. For example, when the user clicks an upload file button in browser at the client side, a unique upload file button ID may be used as an action ID of the action. According to embodiments of the present invention, in addition to one or more identifiers, the user behavior records may further comprise supplemental information for identifying the user behaviors, such as an action's execution time period, action's duration, session's duration, and so on.

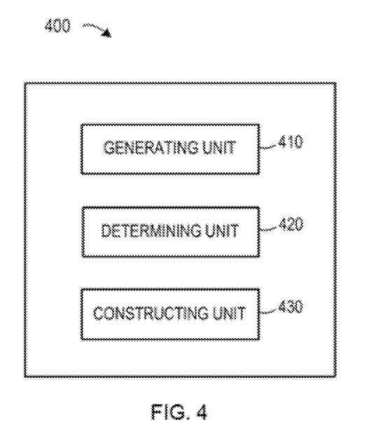

It is to be noted that the user behavior records 111 and 112 in the system 100 may be collected from different clients in a distributed manner or collected from the same server or different servers. Apparatus 120 may be implemented at any server side associated with different clients, or implemented at a controller that controls or manages a server as discussed above. Apparatus 120 may be implemented as an apparatus 400 for analyzing user behaviors according to embodiments of the present invention as shown in FIG. 4. Details will be presented below with reference to FIG. 4.

Sequence pattern repository 130 may comprise one or more sequence patterns that are constructed by apparatus 120 according to the user behavior records 111 and 112. According to embodiments of the present invention, a sequence pattern may contain an action sequence that indicates actions performed by the user and an order of the actions. Optionally or additionally, the sequence pattern may include a key action ID that is an identification of the first mandatory action in the action sequence contained in the sequence pattern. Optionally or additionally, the sequence pattern may include a set of users that perform the action sequence contained in the sequence pattern, and may include the number of times each user in the set of users executes the action sequence.

In addition, note although FIG. 1 only shows two user behavior records 111 and 112, the number of user behavior records as shown is merely illustrative and is not intended to limit the scope of the present invention. For example, there may be a random number of user behavior records that may record behaviors of one or more users.

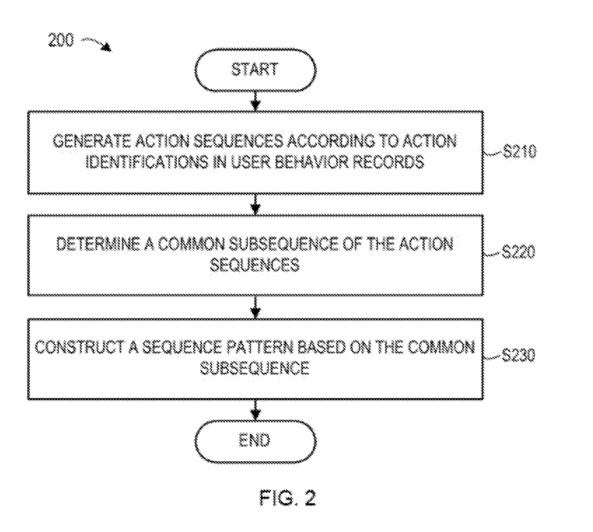

FIG. 2 shows a flowchart of a method for analyzing user behaviors according to one exemplary embodiment of the present invention. A method 200 may be executed by one or more servers storing user behavior records, a controller managing or controlling the server(s), or any apparatus capable of directly or indirectly retrieving user behavior records.

After method 200 starts, in step S210, action sequences are generated according to action IDs in user behavior records.

According to embodiments of the present invention, action sequences may be generated according to action IDs in user behavior records by various means. In one embodiment, a user session ID may be extracted from user behavior records, and an action sequence associated with the user session ID may be generated from an action ID in user behavior records. The user session ID indicates a procedure from user login to logout, wherein user logout may include user normal logout and logout caused by timeout and other reason.

In step S220, a common subsequence is determined based on the action sequences, wherein the common subsequence is a subsequence that is common to at least two action sequences in the action sequences.

The action sequence may indicate orders and a procedure of actions performed by the user. Since the user might repeat one or more actions, it is possible that the action sequence generated in step S210 includes repeated actions. In this view, in one embodiment of the present invention, the action sequence may be deduplicated so as to remove repeated action IDs. Then, the common subsequence may be determined based on the deduplicated action sequence.

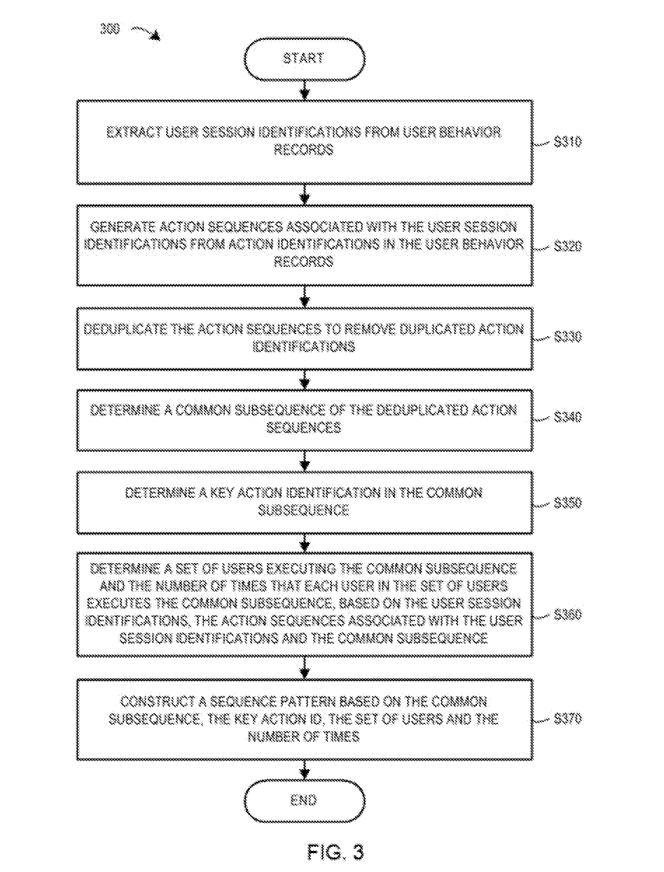

The common subsequence may be determined in various manners. In some embodiments, the longest common subsequence for every two action sequences may be determined for each user. In some other embodiments, a predefined length may be preset for a common subsequence, and then a predefined-length common subsequence of every two action sequences may be determined with respect to each user. Relevant details will be described in step S340 with reference to FIG. 3.

In step S230, a sequence pattern is constructed based on the common subsequence.

According to embodiments of the present invention, a sequence pattern may be constructed in various structures. In some embodiments, the sequence pattern may comprise, for example, the common subsequence determined in step S220 and a key action ID determined according to the common subsequence. In such embodiments, the key action ID in the common subsequence may be determined, wherein the key action ID is an identification of the first mandatory action in the common subsequence; then, the sequence pattern is constructed based on the common subsequence and the key action ID.

In other embodiments, the sequence pattern may comprise, for example, the common subsequence determined in step S220, a set of users executing the common subsequence, and related information. In such embodiments, a set of users executing the common subsequence and the number of times that each user in the set of users executes the common subsequence may be determined according to the user session ID, action sequences associated with the user session ID and the common subsequence. Then, the sequence pattern may be constructed based on the common subsequence, the set of users, and the number of times that each user executes the common subsequence.

In further embodiments, the sequence pattern may comprise, for example, the common subsequence determined in step S220, a key action ID, a set of users executing the common subsequence and related information. In this case, a key action ID in the common subsequence may be determined, and a set of users executing the common subsequence and the number of times that each user in the set of users executes the common subsequence may be determined. Then, the sequence pattern may be constructed based on the common subsequence, the set of users and the number of times that each user in the set of users executes the common subsequence. Details will be described below with reference to steps S350 to S370 in FIG. 3.

FIG. 3 shows a flowchart of a method 300 for analyzing user behaviors according to another exemplary embodiment of the present invention. The method 300 is a concrete implementation of method 200 in FIG. 2. In method 300, action sequences associated with user session IDs are generated from action IDs in user behavior records, and a sequence pattern is constructed based on a common subsequence determined according to the action sequences, a key action ID determined from the common subsequence, a set of users executing the common subsequence, and the number of times that each user in the set of users executes the common subsequence. Method 300 may be executed by one or more servers storing user behavior records, a controller managing or controlling the server(s), or other apparatus capable of directly or indirectly retrieving user behavior records.

After method 300 starts, user session IDs are extracted from user behavior records in step S310.

According to embodiments of the present invention, user behavior records may be logs for recording user behaviors or any other appropriate files, for example including, but not limited to, logs of the server side, logs of the client side, and so forth. User behavior records may store one or more user session IDs. One session may be, for example, the procedure from user login to logout, wherein the logout may be normal logout or timeout logout. One user session ID may be associated with one session. A user may perform one or more actions in the procedure from login to logout, and these actions may be actions associated with the user session ID. According to embodiments of the present invention, in addition to user session IDs, user behavior records may further store action IDs, each of which may identify one of actions associated with each user session IDs.

In step S320, action sequences associated with the user session IDs are generated from action IDs in the user behavior records.

An action ID associated with the user session ID may be looked up in the user behavior records, and an action sequence is generated in order of found action IDs. The action sequence may comprise one or more action IDs and orders of the action IDs, for indicating actions executed by the user and the execution orders. The order of action IDs may be determined in execution order of actions corresponding to the action IDs, for example.

In one embodiment, user behavior records may include supplemental information to identify user behaviors, such as action's execution time period, action's duration, session's duration, and so on. According to the actions' execution time period, execution order of various actions may be determined. Accordingly, order of action IDs corresponding to various actions may be determined. For instance, user behavior records may comprise two action IDs associated with a given user session ID, which identify action A and action B respectively. It is supposed that action A is executed before action B according to supplemental information, and an action sequence A->B may be generated.

In another embodiment, the user may repeat the same actions in one session, so user behavior records may include multiple action IDs, one part of which may be duplicated action IDs. For example, in one session the user may perform action A three times, then perform action B twice and later perform action C. In this case, an action sequence associated with user session IDs of this session may be A->A->A->B->B->C. According to optional embodiments of the present invention, an action sequence having duplicated action IDs may be deduplicated, so that the action sequence can be simplified.

In step S330, the action sequences are deduplicated so as to remove duplicated action IDs.

Still in reference to the above embodiment, if the action sequence generated in step S320 is A->A->A->B->B->C, multiple neighboring action IDs which are the same in the action sequence may be simplified as one action ID, for example, A->A->A may be simplified as A, and B->B may be simplified as B. Therefore, it may be determined a deduplicated action sequence A->B->C.

Note the deduplication in step S330 is optional rather than essential to embodiments of the present invention. In some embodiments of the present invention, the solution of the present invention can be implemented even if action sequences are not deduplicated.

In step S340, a common subsequence is determined based on the deduplicated action sequences.

Regarding every two action sequences, if they have the same subsequence, then it may be determined that there is a common subsequence. For example, regarding two action sequences A->B->C and A->B->D, it may be determined that their common subsequence is A->B.

According to embodiments of the present invention, regarding multiple action sequences executed by each user, the longest common subsequence for every two action actions may be determined, wherein the longest common subsequence may include a continuous common subsequence or a non-continuous common subsequence. For example, regarding two action sequences A->B->C->D->F and A->C->D->E, it may be determined that their longest continuous common subsequence is C->D and the longest non-continuous common subsequence is A->C->D. Regarding another two action sequences A->B->C->D->F and A->B->C->D->E, it may be determined that their longest common subsequence is A->B->C->D. It may be determined whether the longest continuous common subsequence or the non-continuous common subsequence is to be used according to actual situations.

Note in the embodiment of the present invention, the common subsequence determined in step S340 may not be the longest subsequence for two action sequences. As an alternative, for each user, a predefined-length common subsequence for every two action sequences may be determined. In such an embodiment, calculation stops when the common subsequence reaches the predefined length, thereby resources and overheads can be saved and the processing speed can be increased. For example, regarding two action sequences A->B->C->D->F and A->B->C->D->E, when the predefined length is set to 2, the common subsequence may be A->B, B->C or C->D; when the predefined length is set to 3, the common subsequence may be A->B->C or B->C->D; when the predefined length is set to 4, the common subsequence may be A->B->C->D. Additionally, it is to be noted that the common subsequence may include a continuous common subsequence or a non-continuous common subsequence.

After executing step S340, one or more common subsequences may be obtained. According to embodiments of the present invention, one or more sequence patterns may be constructed based on the one or more common subsequences. In this way, each constructed sequence pattern may include a sequence, which is one of the resulting one or more common subsequences. In addition, each sequence pattern may include a unique pattern ID for differentiating different sequence patterns.

According to another embodiment of the present invention, in addition to the common subsequence, the sequence pattern may be constructed based on a key action, a user set, and so on, which will be described in detail with reference to steps S350 to S370.

In step S350, a key action ID in the common subsequence is determined.

The key action may be the first mandatory action in the common subsequence, and the key action ID is an ID of the key action. For example, when the common subsequence determined in step S340 is A->C->D->E, if E corresponds to a target action which the user actually wants to perform, then A, C and D correspond to pre-actions of the target action respectively. If at this point there is further one common subsequence B->C->D->E, wherein B, C and D correspond to pre-actions of the target action respectively, then it may be determined that C and D correspond to mandatory actions before performing the target action E, and C corresponds to the first one of these mandatory actions. Therefore, it may be determined that the key action ID in the common subsequence A->C->D->E is C.

According to embodiments of the present invention, the key action may be determined in various manners. In some embodiments, when multiple common subsequences are obtained in step S340, wherein one of common subsequences (referred to as “sequence 1” for short) is A->B>-C->D->E, then the key action may be determined as below.

(1) If there is another common subsequence (referred to as “sequence 2” for short), i.e., C->D, then all actions before sequence 2 in sequence 1, i.e., actions A and B are not mandatory actions. In the meanwhile, it may be determined that actions C and D are mandatory actions, and the first action C may be determined as the key action.

(2) If there are further more common subsequences, for example, two common subsequences C->D and A->B that are both subsets of sequence 1, then the common subsequence nearest to the end of sequence 1 will be regarded as sequence 2, and the first action C in sequence 2 may be determined as the key action.

(3) If no other common subsequence is a subset of sequence 1, then the first action A in sequence 1 may be determined as the key action.

Note the foregoing examples are merely exemplary and not limiting the present invention. Those skilled in the art may determine the key action in the common subsequence by other known technical means.

In step S360, a set of users executing the common subsequence and the number of times that each user in the set of users executes the common subsequence are determined according to the user session ID, action sequences associated with the user session ID and the common subsequence.

As described above, regarding the action sequences associated with the user session ID as generated in step S320, statistics may be made in step S360 on whether each action sequence contains the common subsequence, so that it may be determined which user or users execute(s) the common subsequence, and how many times each user executes the common subsequence.

Note, although steps S350 and S360 are described in a particular order in the drawings, it does not require or imply that these operations must be performed according to this particular order, or a desired outcome can only be achieved by performing all shown operations. On the contrary, the execution order for the steps as depicted in the flowcharts may be varied. For example, in the embodiment of the present invention, besides executing step S350 first and then step S360, step S360 may be executed first and then step S350, or steps S350 and S360 may be executed concurrently.

In step S370, a sequence pattern is constructed based on the common subsequence, the key action ID, the set of users and the number of times that the user executes the common subsequence.

In the embodiment of the present invention, the sequence pattern may comprise, for example, the common subsequence, the key action ID, the set of users executing the common subsequence, and/or related information. A structure of the sequence pattern according to embodiments of the present invention is shown as below:
Sequence pattern={pattern ID, sequence, key action ID, set of users <user ID, number of execution times>}

In the sequence pattern, the pattern ID is a unique identifier of each sequence pattern, for differentiating different sequence patterns; the sequence may be a common subsequence determined according to embodiments of the present invention; the key action ID may be an identification of the key action determined in step S350, for example; the set of users <user ID, number of execution times> represents a set that consists of one of more user IDs, wherein each user ID is stored in correspondence to the number of times (i.e., execution times) that the user executes the sequence in the sequence pattern.

Note the foregoing structure of the sequence pattern is merely illustrative and not limiting the present invention. Those skilled in the art may implement the structure of the sequence pattern in other forms. For example, in some other embodiments according to the present invention, the sequence pattern may further have one of the following structures:
Sequence pattern={pattern ID, sequence}
Sequence pattern={pattern ID, sequence, key action ID}
Sequence pattern={pattern ID, sequence, user set <user ID>}
Sequence pattern={pattern ID, sequence, key action ID, user set <user ID>}

The sequence pattern constructed based on the embodiment of the present invention may have various applications, for example, providing recommendations to users, optimizing user interface design, promoting personalized user interface customization, optimizing test operations, pre-processing time-consuming actions, security control, and so on.

In some embodiments according to the present invention, user interface design may be optimized according to the sequence pattern. According to some embodiments, accessibility of actions corresponding to action IDs in a sequence in the sequence pattern may be determined By determining the accessibility of actions, user interface design may be modified and adjusted, for example, the design of actions with low accessibility may be changed so as to facilitate user access.

By way of example, if there are quite a few pre-actions before performing a target action, then the accessibility of the target action is relatively low. In this case, the accessibility of the target action may be increased by creating a shortcut, for example, re-designing a web page. For example, when a sequence in the sequence pattern is A->B->C->D->E, if E is the key action, then it means that four actions A, B, C, and D have to be performed before performing the target action E, i.e., the accessibility of E is low. According to embodiments of the present invention, if a user set in the sequence pattern consists of many user IDs, then it means that the key action is commonly used to many users, so shortcuts may be created on the homepage for users so that users can execute the action conveniently and quickly.

According to embodiments of the present invention, the accessibility of an action indicates the difficulty degree of the action; the more pre-actions an action has, the lower the accessibility of the action. The accessibility may be determined in various manners. In one embodiment, a position of the key action ID in a sequence and length of the sequence may be determined, and the accessibility of a target action may be determined based on the position and the length of the sequence. One example of calculating the accessibility is presented below:

$$Accessibility = \frac{keypos}{lengthP + {λ ( lengthP - keypos )}^{2}} \qquad ( 2 )$$

wherein Accessibility represents the accessibility of the target action in a sequence pattern;
lengthP represents length of a sequence in the sequence pattern;
keypos represents a position of the target action ID in the sequence; and
λ represents an adjustment factor for adjusting the accessibility calculation based on some factors that may comprise, for example, the length of a sequence in the sequence pattern, frequency that the sequence pattern is used, and so on. For example, if a sequence in sequence pattern 1 is longer while a sequence in sequence pattern 2 is shorter, then the accessibility of an action in sequence pattern 1 is less than the accessibility of an action in sequence pattern 2. According to embodiments of the present invention, λ may be larger than or equal to 0.

For instance, in one embodiment, a sequence in sequence pattern 1 may be A->B (wherein A is the key action), and a sequence in sequence pattern 2 may be A->B->C->D->E->F (wherein C is the key action). If λ=0, then the accessibility of target action F is 3/(6+0), which is equals to 1/2; if λ=1, then the accessibility of target action F is 3/(6+3²), less than 1/2. It can be seen that a calculation result of the accessibility may be adjusted using λ.

In some embodiments according to the present invention, user similarity may be determined according to the sequence pattern; then users may be grouped according to the user similarity. In some embodiments, the similarity between user 1 and user 2 may be determined by determining how many common sequence patterns are between sequence patterns associated with user 1 and sequence patterns associated with user 2. For example, if there are more common sequence patterns, the similarity between user 1 and user 2 is higher; and if there are less common sequence patterns, the similarity between user 1 and user 2 is lower. In other embodiments, it may be determined how many unpopular sequence patterns are shared between sequence patterns associated with user 1 and sequence patterns associated with user 2. If more unpopular sequence patterns are shared, it may be determined the similarity between user 1 and user 2 is higher; and if less unpopular sequence patterns are shared, it may be determined the similarity between user 1 and user 2 is lower. In further embodiments, the ratio of sequence patterns shared between sequence patterns associated with user 1 and sequence patterns associated with user 2 may be decided. If the ratio is higher, it may be determined the similarity between user 1 and user 2 is higher; and if the ratio is lower, it may be determined the similarity between user 1 and user 2 is lower.

In some embodiments according to the present invention, sequence patterns associated with the user may be ranked by the number of times that the user executes sequences in these sequence patterns. One or more sequence patterns may be selected from the ranked sequence patterns. The key action ID in the one or more sequence patterns may be obtained so as to be recommended to the user or other users having high similarity with the user.

In some embodiments according to the present invention, the sequence pattern may be used as a test case to increase the test efficiency and speed. Since such a test case is dynamically obtained from real user scenarios rather than being static test design, the test procedure can be improved effectively.

In some embodiments according to the present invention, in view that some time-consuming actions which degrade user experience, action IDs of these time-consuming actions in sequences of the sequence pattern as well as pre-action IDs of these action IDs may be determined. Then, in response to monitoring actions corresponding to pre-action IDs are performed, time-consuming actions are pre-processed. The pre-processing may be implemented in various ways, for example, pre-loading some resources, executing some queries, and so on. In this manner, when the user performs the action, the system can respond quickly, thereby increasing user experience.

In some embodiments according to the present invention, a pre-defined set of unsafe sequence patterns may be obtained. In response to monitoring a sequence in unsafe sequence patterns in the set is executed, system administrators or users executing the sequence may be alerted. Thereby, some unsafe actions may be alerted early and the system security is increased.

Now with reference to FIG. 4, this figure shows a block diagram of an apparatus for analyzing user behaviors according to one exemplary embodiment of the present invention. According to embodiments of the present invention, apparatus 400 may be implemented at one or more servers storing user behavior records, a controller managing or controlling the server(s), or other apparatus capable of obtaining user behavior records directly or indirectly. According to embodiments of the present invention, apparatus 120 described with reference to FIG. 1 may be implemented according to apparatus 400.

As shown in this figure, apparatus 400 comprises: a generating unit 410 configured to generate action sequences according to action IDs in user behavior records; a determining unit 420 configured to determine a common subsequence based on the action sequences, the common subsequence being a subsequence that is common to at least two action sequences among the action sequences; and a constructing unit 430 configured to construct a sequence pattern based on the common subsequence.

According to embodiments of the present invention, the generating unit 410 may comprise: an extracting unit configured to extract a user session ID from the user behavior records, wherein the user session ID is associated with a procedure from user login to logout, wherein generating unit 410 may be further configured to generate an action sequence associated with the user session ID from the action IDs in the user behavior records.

According to embodiments of the present invention, the generating unit 410 may further comprise: a lookup unit configured to look up action IDs associated with the user session ID in the user behavior records, wherein generating unit 410 may be further configured to generate the action sequence according to orders of the action IDs.

According to embodiments of the present invention, the determining unit 420 may comprise: a deduplicating unit configured to deduplicate the action sequence so as to remove duplicated action IDs, wherein determining unit 420 may further be configured to determine the common subsequence based on the deduplicated action sequences.

According to embodiments of the present invention, the determining unit 420 may be further configured to: determine, with respect to each user, a longest common subsequence or a predefined-length common subsequence for every two action sequences.

According to embodiments of the present invention, the constructing unit 430 may comprise: a key action determining unit configured to determine a key action ID in the common subsequence, wherein the key action ID is an identification of a first mandatory action in the common subsequence. The constructing unit 430 may further be configured to construct the sequence pattern based on the common subsequence and the key action ID.

According to embodiments of the present invention, the constructing unit 430 may comprise: a user determining unit configured to determine a set of users executing the common subsequence and a number of times that each user in the set of users executes the common subsequence, based on a user session identification, an action sequence associated with the user session identification and the common subsequence. The constructing unit 430 may further be configured to construct the sequence pattern based on the common subsequence, the set of users and the number of times.

According to embodiments of the present invention, the apparatus 400 may further comprise: a similarity determining unit configured to determine user similarity according to the sequence pattern; and a grouping unit configured to group users according to the user similarity.

According to embodiments of the present invention, the apparatus 400 may further comprise: an accessibility determining unit configured to determine accessibility of an action corresponding to an action ID in a sequence in the sequence pattern.

According to embodiments of the present invention, the accessibility determining unit may comprise: a position determining unit configured to determine a position of the action ID in the sequence and length of the sequence, wherein the accessibility determining unit may further be configured to determine accessibility of the action based on the position and the length of the sequence.

According to embodiments of the present invention, the apparatus 400 may further comprise: a ranking unit configured to rank sequence patterns associated with a user according to the number of times that the user executes a sequence in the sequence pattern; a selecting unit configured to select one or more sequence patterns from the ranked sequence patterns; and a recommending unit configured to obtain key action ID(s) in the one or more sequence patterns so as to make recommendation to the user or a further user having high similarity with the user.

According to embodiments of the present invention, the apparatus 400 may further comprise: a time consumption analyzing unit configured to determine an action identification of a time-consuming action and a preceding action identification of the determined action identification in a sequence of the sequence pattern; and a pre-processing unit configured to pre-process the time-consuming action in response to monitoring that an action corresponding to the pre-action IDs is performed.

According to embodiments of the present invention, the apparatus 400 may further comprise: an obtaining unit configured to obtain a predefined set of unsafe sequence patterns; and an alerting unit configured to, in response to monitoring that a sequence of an unsafe sequence pattern in the set is executed, alert a system administrator or a user executing the sequence.

For the clarity purpose, FIG. 4 does not show optional units of apparatus 400 and sub-units contained in each unit. However, it should be understood that all features described with respect to FIG. 1 are also applicable to apparatus 400 and are thus not detailed here.

It should be understood that apparatus 400 may be implemented in various forms. For example, in some embodiments, apparatus 400 may be implemented using software and/or firmware. For example, apparatus 400 may be implemented as a computer program product embodied on a computer readable medium, wherein each unit is a program module that achieves its function by computer instructions. Alternatively or additionally, apparatus 400 may be implemented partially or completely based on hardware. For example, apparatus 400 may be implemented as an integrated circuit (IC) chip, application-specific integrated circuit (ASIC) or system on chip (SOC). Other forms that are currently known or to be developed in future are also feasible. The scope of the present invention is not limited in this regard.

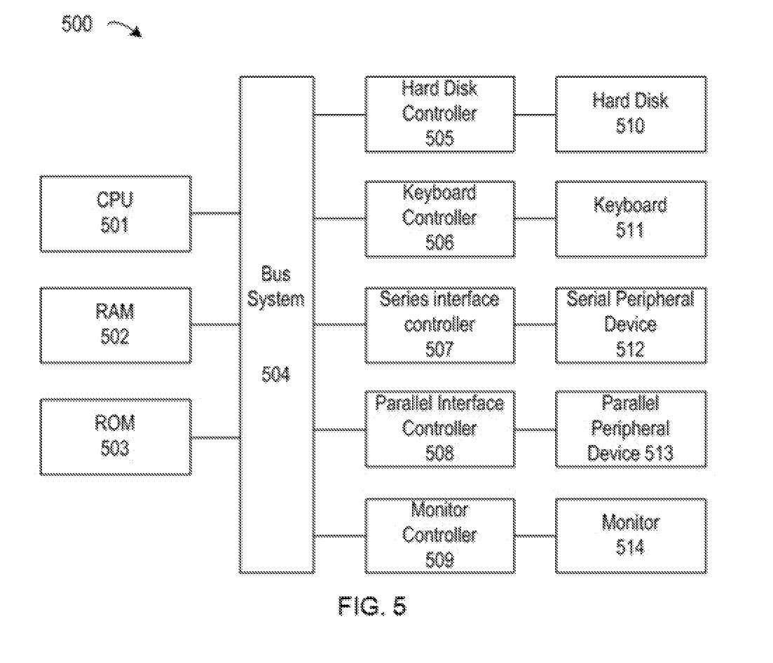

Reference is now made to FIG. 5, which shows a schematic block diagram of a computer system 500 that is applicable to implement the embodiments of the present invention. As shown in FIG. 5, the computer system may include: a CPU (Central Processing Unit) 501, a RAM (Random Access Memory) 502, a ROM (Read Only Memory) 503, a system bus 504, a hard disk controller 505, a keyboard controller 506, a serial interface controller 507, a parallel interface controller 508, a monitor controller 509, a hard disk 510, a keyboard 511, a serial peripheral device 512, a parallel peripheral device 513 and a monitor 514. Among these devices, connected to the system bus 504 are the CPU 501, the RAM 502, the ROM 503, the hard disk controller 505, the keyboard controller 506, the serial interface controller 507, the parallel interface controller 508 and the monitor controller 509. The hard disk 510 is coupled to the hard disk controller 505; the keyboard 511 is coupled to the keyboard controller 506; the serial peripheral device 512 is coupled to the serial interface controller 507; and the parallel peripheral device 513 is coupled to the parallel interface controller 508; and the monitor 514 is coupled to the monitor controller 509. It should be understood that the structural block diagram in FIG. 5 is shown only for illustration purpose, and is not intended to limit the scope of the present invention. In some cases, some devices may be added or reduced as required.

As above mentioned, the apparatus 400 may be implemented through pure hardware, for example, chip, ASIC, SOC, and so on. Such hardware may be integrated into computer system 500. Besides, the embodiments of the present invention may also be implemented in a form of a computer program product. For example, the method of the present invention may be implemented via a computer program product. This computer program product may be stored in RAM 502, ROM 503, hard disk 510 and/or any suitable storage medium as illustrated in FIG. 5, or downloaded to computer system 500 from a suitable location in the network. The computer program product may comprise computer code portions comprising program instructions that may be executed through a suitable processing device (for example, CPU 501 as shown in FIG. 5). The program instruction at least may comprise instructions for implementing the steps of the method of the present invention.

It should be noted that, the embodiments of the present invention can be implemented in software, hardware or the combination thereof. The hardware part can be implemented by a dedicated logic; the software part can be stored in a memory and executed by a proper instruction execution system such as a microprocessor or a design-specific hardware. One of ordinary skill in the art may understand that the above-mentioned method and system may be implemented with a computer-executable instruction and/or in a processor controlled code, for example, such code is provided on a bearer medium such as a magnetic disk, CD, or DVD-ROM, or a programmable memory such as a read-only memory (firmware) or a data bearer such as an optical or electronic signal bearer. The apparatuses and their modules in the present invention may be implemented by hardware circuitry of a very large scale integrated circuit or gate array, a semiconductor such as logical chip or transistor, or a programmable hardware device such as a field-programmable gate array or a programmable logical device, or implemented by software executed by various kinds of processors, or implemented by combination of the above hardware circuitry and software such as firmware.

It should be noted that although a plurality of units or subunits of the apparatuses have been mentioned in the above detailed depiction, such partitioning is merely non-compulsory. In actuality, according to the embodiments of the present invention, the features and functions of two or more units above described may be embodied in one unit. On the contrary, the features and functions of one unit above described may be further partitioned to be embodied in more units.

Besides, although operations of the method of the present invention are described in a particular order in the drawings, it does not require or imply that these operations must be performed according to this particular order, or a desired outcome can only be achieved by performing all shown operations. On the contrary, the execution order for the steps as depicted in the flowcharts may be varied. Additionally or alternatively, some steps may be omitted, a plurality of steps may be merged into one step for execution, and/or a step may be divided into a plurality of steps for execution.

Although the present invention has been depicted with reference to a plurality of embodiments, it should be understood that the present invention is not limited to the disclosed embodiments. On the contrary, the present invention intends to cover various modifications and equivalent arrangements included in the spirit and scope of the appended claims. The scope of the appended claims meets the broadest explanations and covers all such modifications and equivalent structures and functions.

1. A method of analyzing user behaviors, comprising:
generating action sequences according to action identifications in user behavior records;
determining a common subsequence based on the action sequences, the common subsequence being a subsequence that is common to at least two action sequences among the action sequences; and
constructing a sequence pattern based on the common subsequence.

2. The method according to claim 1, wherein the generating action sequences according to action identifications in user behavior records comprises:
extracting a user session identification from the user behavior records, wherein the user session identification is associated with a procedure from user login to logout; and
generating an action sequence associated with the user session identification from the action identifications in the user behavior records.

3. The method according to claim 2, wherein the generating an action sequence associated with the user session identification from action identifications in the user behavior records comprises:
looking up action identifications associated with the user session identification in the user behavior records; and
generating the action sequence according to orders of the action identifications.

4. The method according to claim 1, wherein the determining a common subsequence based on the action sequences comprises:
deduplicating the action sequences to remove duplicated action identifications; and
determining the common subsequence based on the deduplicated action sequences.

5. The method according to claim 4, wherein the determining the common subsequence based on the deduplicated action sequences comprises:
with respect to each user, determining a longest common subsequence or a predefined-length common subsequence for every two action sequences.

6. The method according to claim 1, wherein the constructing a sequence pattern based on the common subsequence comprises:
determining a key action identification in the common subsequence, wherein the key action identification is an identification of a first mandatory action in the common subsequence; and
constructing the sequence pattern based on the common subsequence and the key action identification.

7. The method according to claim 1, wherein the constructing a sequence pattern based on the common subsequence comprises:
determining a set of users executing the common subsequence and a number of times that each user in the set of users executes the common subsequence, based on a user session identification, an action sequence associated with the user session identification and the common subsequence; and
constructing the sequence pattern based on the common subsequence, the set of users and the number of times.

8. The method according to claim 1, further comprising:
determining user similarity according to the sequence pattern; and
grouping users according to the user similarity.

9. The method according to claim 1, further comprising:
determining accessibility of an action corresponding to an action identification in a sequence in the sequence pattern.

10. The method according to claim 9, wherein the determining accessibility of an action corresponding to an action identification in a sequence in the sequence pattern comprises:
determining a position of the action identification in the sequence and length of the sequence; and
determining accessibility of the action based on the position and the length of the sequence.

11. The method according to claim 1, further comprising:
ranking sequence patterns associated with a user according to a number of times that the user executes a sequence in the sequence pattern;
selecting one or more sequence patterns from the ranked sequence patterns; and
obtaining a key action identification in the one or more sequence patterns so as to make recommendation to the user or a further user having high similarity with the user.

12. The method according to claim 1, further comprising:
determining an action identification of a time-consuming action and a preceding action identification of the determined action identification in a sequence of the sequence pattern; and
pre-processing the time-consuming action in response to monitoring that an action corresponding to the pre-action identification is performed.

13. The method according to claim 1, further comprising:
obtaining a predefined set of unsafe sequence patterns; and
in response to monitoring that a sequence of an unsafe sequence pattern in the set is executed, alerting a system administrator or a user executing the sequence.

14. An apparatus for analyzing user behaviors, comprising:
a generating unit configured to generate action sequences according to action identifications in user behavior records;
a determining unit configured to determine a common subsequence based on the action sequences, the common subsequence being a subsequence that is common to at least two action sequences among the action sequences; and
a constructing unit configured to construct a sequence pattern based on the common subsequence.

15. The apparatus according to claim 14, wherein the generating unit comprises:
an extracting unit configured to extract a user session identification from the user behavior records, wherein the user session identification is associated with a procedure from user login to logout,
wherein the generating unit is further configured to generate an action sequence associated with the user session identification from the action identifications in the user behavior records.

16. The apparatus according to claim 14, wherein the determining unit comprises:
a deduplicating unit configured to deduplicate the action sequences to remove duplicated action identifications,
wherein the determining unit is further configured to determine the common subsequence based on the deduplicated action sequences.

17. The apparatus according to claim 14, wherein the constructing unit comprises:
a key action determining unit configured to determine a key action identification in the common subsequence, wherein the key action identification is an identification of a first mandatory action in the common subsequence,
wherein the constructing unit is further configured to construct the sequence pattern based on the common subsequence and the key action identification.

18. The apparatus according to claim 14, wherein the constructing unit comprises:
a user determining unit configured to determine a set of users executing the common subsequence and a number of times that each user in the set of users executes the common subsequence, based on a user session identification, an action sequence associated with the user session identification and the common subsequence,
wherein the constructing unit is further configured to construct the sequence pattern based on the common subsequence, the set of users and the number of times.

19. The apparatus according to claim 14, further comprising:
a similarity determining unit configured to determine user similarity according to the sequence pattern; and
a grouping unit configured to group users according to the user similarity.
